(19) United States
(12) Patent Application Publication
(10) Pub. No.: US 2005/0238192 A1
(43) Pub. Date: Oct. 27, 2005

(54) Shell in shell hearing aid system

(76) Inventors: Richard Harvey Ford, Braselton, GA (US); Timothy O'Brian Pepper, Kennesaw, GA (US)

Correspondence Address: GREG O'BRADOVICH, P.C., 295 CULVER STREET, SUITE A, LAWERENCEVILLE, GA, 30045, US

(21) Appl. No.: 10/833,235

(22) Filed: Apr. 27, 2004

(51) Int. Cl. H04R 25/00

(52) U.S. Cl. 381/322; 381/324; 381/328

(57) ABSTRACT

A shell in shell hearing aid system and hearing aid wax guard apparatus. The hearing system includes a hearing aid electronic and transducer unit having a housing and stem. The system further includes a custom shell component that is formed for affixation around the stem. The system further includes an end cap that connects to the end of the stem and holds the custom shell around the stem. The end cap can be the hearing aid wax guard apparatus having a series of flap seals, a bell-shaped dome and tear drop speaker opening.

### BACKGROUND

I. Field of the Invention

The present invention relates generally to the field of hearing aids and more particularly to a shell in shell hearing aid system and wax guard apparatus.

II. Description of the Related Art.

Present hearing aids are typically custom fit in order to accommodate the different shapes and structures of ears of different individuals. Hearing aids must be custom molded and then manufactured to the individual's specifications. As such, an individual who has been fit with a hearing aid must wait until the hearing aid has been built to the individual's specifications before the individual can use the hearing aid. In a typical hearing aid, the custom shell is built around the internal hearing aid electronics and transducers. Furthermore, the custom-built hearing aids tend to be bulky and often uncomfortable.

In addition, with conventional hearing aids the speaker opening is located parallel to the path that the hearing aid travels when it is inserted into the ear canal. By being parallel in this manner, wax in the ear canal can directly enter the speaker opening, thereby impacting wax in the speaker opening

### SUMMARY

In general, the present invention features a shell in shell hearing aid system and a hearing aid wax guard apparatus. The hearing system includes a hearing aid electronic and transducer unit having a housing and stem. The system further includes a custom shell component that is formed for affixation around the stem. The system further includes an end cap that connects to the end of the stem and holds the custom shell around the stem. The end cap can be the hearing aid wax guard apparatus having a series of flap seals, a bell-shaped dome and tear drop speaker opening.

In general, in one aspect, the invention features a hearing aid apparatus, including a electronics and transducer unit, a custom shell connected to and surrounding a portion of the unit and an end cap connected to the unit.

In one implementation, the unit comprises a housing and a stem connected to the housing.

In another implementation, the apparatus further includes a protrusion connected to the stem and a barb connected to the protrusion.

In another implementation, the custom shell comprises an inner shell nested in an outer shell.

In another implementation, the inner shell surrounds the stem.

In still another implementation, the stem is surrounded by a stem-shell portion of the inner shell and wherein the housing is cradled in a housing-shell portion of the inner shell.

In yet another implementation, the apparatus further includes a longitudinal axis defined along the stem and along the custom shell.

In another implementation, the end cap includes a speaker opening oriented perpendicular to the longitudinal axis.

In another implementation, the end cap further comprises an opening oriented along the longitudinal axis and connected to the barb.

In another aspect, the invention features a hearing aid kit, including an electronics and transducer unit having a housing and a stem having a protrusion and a barb, an inner shell optionally adapted to fit onto and surround the stem and to cradle a portion of the housing, the inner shell having a housing shell portion and a stem-shell portion, an outer shell adapted to be formed around the inner shell, the outer shell having an outer surface molded to an ear canal, and an end cap having an opening adapted to receive the barb, the end cap being adapted to retain the inner and outer shells on the stem.

In one implementation, the end cap is further adapted to connect to the stem in the absence of the inner and outer shells.

In another implementation, the kit further includes flap seals connected to a housing portion of the end cap, the flap seals being adapted to retain the hearing aid in an ear canal in the absence of the inner shell.

In another implementation, the barb includes a speaker opening adapted to fit into a hollow interior of the end cap.

In another implementation, the end cap includes an opening oriented about a longitudinal axis common to a longitudinal axis of the barb speaker opening and a side speaker channel oriented generally perpendicular to the longitudinal axis.

In another implementation, the barb speaker opening is acoustically coupled to the side speaker channel when the opening of the end cap is connected to the barb.

In still another aspect, the invention features a hearing aid system, including an electronics and transducer unit having a housing and a stem having a protrusion and a barb, the housing having an operational face including a transducer opening, an inner shell surrounding the stem and cradling a portion of the housing, the inner shell having a housing shell portion, a stem-shell portion and an opening through which the protrusion and barb protrude, an outer shell surrounding the inner shell, the outer shell having an outer surface molded to an ear canal, an end cap having an opening connected to the barb, the end cap having a diameter larger than the diameter of the opening of the inner shell through which the protrusion and barb protrude, thereby retaining the inner and outer shells on the stem, wherein the stem, the inner and outer shells and the end cap are oriented about a common longitudinal axis.

In one implementation, the barb includes a speaker opening that is located within a hollow interior of the end cap.

In another implementation, the end cap includes a side channel speaker opening oriented generally perpendicular to the longitudinal axis and acoustically coupled to the hollow interior and to the speaker opening on the barb.

In yet another aspect, the invention features a wax guard apparatus, including a housing having a dome and a hollow interior, the housing being oriented about a longitudinal axis, a side channel through the dome and oriented generally perpendicular to the longitudinal axis, an opening to the side channel, the opening defining a tear drop a portion of the tear drop being disposed through the channel, and another portion of the teardrop forming an indentation, and an opening to the hollow interior oriented about the longitudinal axis opposite the dome, the opening defining a lip adjacent the opening.

In one implementation, the apparatus further includes a first flap seal connected to a mid point location on the housing and being oriented about the longitudinal axis.

In another implementation, the first flap seal overhangs about the housing forming a space underneath the flap seal and about the housing.

In another implementation, the apparatus further includes a second flap seal located adjacent the opening oriented about the longitudinal axis, the second flap seal having a diameter larger than the diameter of the first flap seal.

In another aspect, the invention features a hearing aid, including an electronics and transducer unit having a stem and a housing, means to receive and surround a portion unit, means to surround the means to receive and surround a portion of the unit and means to retain the means to receive and surround the unit on the unit.

One advantage of the invention is that an individual who is fit with a hearing aid can immediately wear a portion of the hearing aid while the custom portion of the hearing aid is being manufactured.

Another advantage of the invention is that the portion of the hearing aid having the hearing aid electronics and transducers can be worn permanently without the need of a custom portion.

Another advantage of the invention is that the hearing aid system prevents wax from building up in the speaker opening.

Another advantage of the invention is that the hearing aid system forms a good seal between the hearing aid and the individual's ear canal.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a perspective view of the constituent components of an embodiment of a shell in shell hearing aid system;

FIG. 1A illustrates an embodiment of a complete shell in shell hearing aid system;

FIG. 2 illustrates a side view of an embodiment of the electronic and transducer unit of an embodiment of a shell in shell hearing aid system;

FIG. 3 illustrates a perspective view of an embodiment of the electronic and transducer housing unit of an embodiment of a shell in shell hearing aid system having an embodiment of a wax guard apparatus connected to it;

FIG. 4 illustrates a side cutaway view of an embodiment of a hearing aid wax guard apparatus;

FIG. 5 illustrates a side view of an embodiment of a shell in shell hearing aid system end cap and wax guard apparatus;

FIG. 6 illustrates a side view of an embodiment of a hearing aid wax guard apparatus;

FIG. 7 illustrates a side view of another embodiment of a hearing aid wax guard apparatus; and

FIG. 8 illustrates a side view of another embodiment of a hearing aid wax guard apparatus.

### DETAILED DESCRIPTION

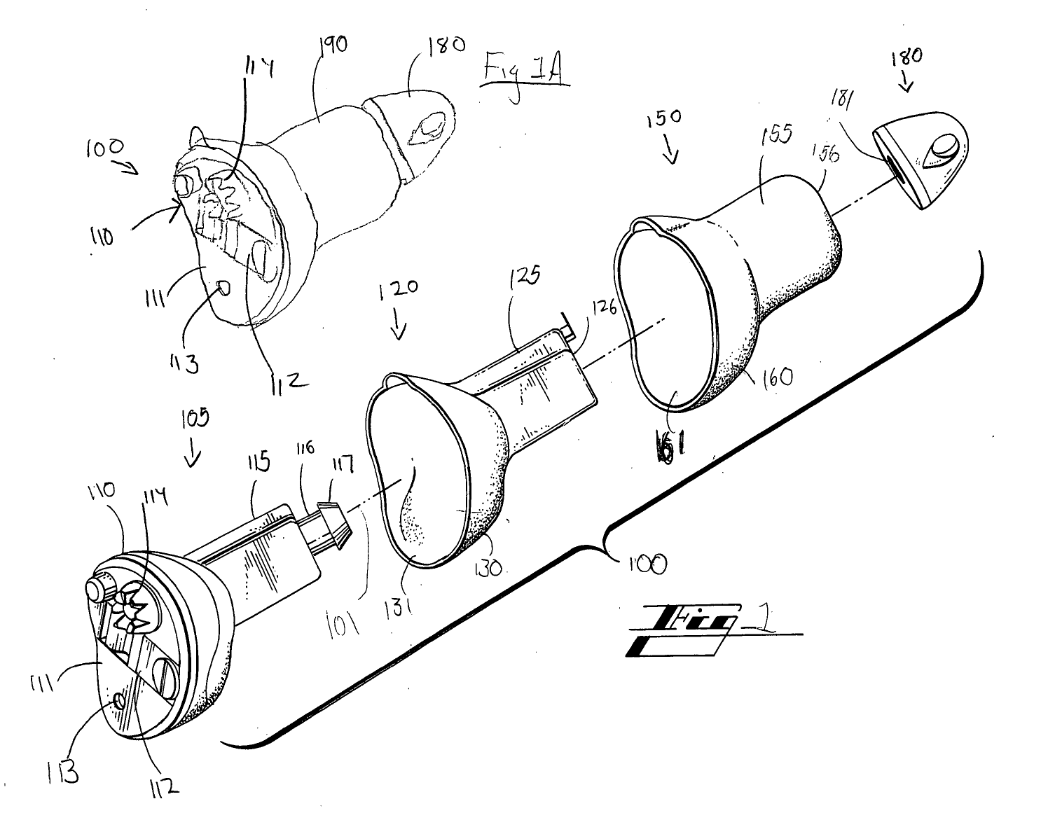

Referring to the drawings wherein like reference numerals designate corresponding parts throughout the several figures, reference is made first to FIG. 1 that illustrates a perspective view of the constituent components of an embodiment of a shell in shell hearing aid system 100. In general, the system 100 includes a hearing aid electronic and transducer unit 105 having a housing 110 and stem 115. The system 100 further includes an inner shell 120 a that is formed for affixation around the stem 115. An outer shell 150 is formed for affixation around the inner shell 120. The inner and outer shells 120, 150 form a custom shell 190 as shown in FIG. 1A. The system 100 further includes an end cap 180 that connects to the end of the stem 115 and holds the custom shell around the stem 115. As discussed further in the description below, the end cap 180 can be the hearing aid wax guard apparatus. In general, in the complete form of the system as shown in FIG. 1A, the unit 105 is nested in the inner shell 120 and the inner shell is nested in the outer shell 150. The stem 115, the inner and outer shells 120, 150 and the end cap 180 are generally oriented about a longitudinal axis 101.

It is appreciated that the unit 105 includes an operational face 111 having conventional controls for a conventional hearing aid such as a battery receptacle 112, a microphone opening 113 and a volume control 114. It is further appreciated that the operational face 111 can include further controls for use with a hearing aid.

In a typical embodiment, the stem 115 has a generally rectangular cross section, although other geometric cross sections are contemplated. The stem 115 further includes a rear protrusion 116 having a barb 117. In a typical embodiment, the rear protrusion 116 and barb 117 can have a generally circular cross section although other geometric cross sections are contemplated. The rear protrusion 116 and barb 117 are a male mating pair for a female receptor 181 on the end cap 180. When the constituent components are assembled as discussed further in the description below, the barb 117 deforms slightly to affix into the female receptor 181. As such, in an implementation, the barb 117 can be a soft and resilient material.

The inner shell 120 generally mimics the outer shape of the unit 105. Therefore, the inner shell 120 includes a stem-shell portion 125 that is generally hollow, thereby forming a channel throughout the length of the stem-shell portion 125, in order to receive the stem 115. The stem-shell portion 125 includes an open outer end 126 so that the rear protrusion 116 and barb 117 can protrude from the stem-shell portion 125. The inner shell 120 further includes a housing-shell portion 130 that is generally hollow in order to receive the housing 110. The housing-shell portion 130 includes an open forward end 131 so that the operational face 111 of the unit 105 can be cradled in the housing-shell portion 130 and be exposed for operation by the patient of the system 100.

The outer shell 150 is the true customizable portion of the custom shell as mentioned above. The outer shell 150 is formed around the inner shell 120 after the unique shape of the patient's ear is determined by taking a cast (mold) of the patient's ear canal. It is appreciated that a custom mold of the patient's ear can be made by conventional methods. The outer shell 150 generally mimics the shape of the inner shell 120 to the extent that the outer shell 150 includes a stem-shell portion 155 that is generally hollow in order to receive the stem-shell portion 125 of the inner shell 120. The stem-shell portion 155 includes an open outer end 156 so that the rear protrusion 116 and barb 117 can protrude from the stem-shell portion 155. The outer shell 150 further includes a housing-shell portion 160 that is generally hollow in order to receive the housing 110. The housing-shell portion 160 includes an open forward end 161 so that the operational face 111 of the unit 105 can be cradled in the housing-shell portion 160 and be exposed for operation by the patient of the system 100.

It is understood that in a typical implementation, the outer shell 150 is formed around the inner shell 120 so that in the finished system 100, the inner and outer shells 120, 150 are a single integral piece. It is further understood that the inner shell 120 and outer shell 150 are shown in FIG. 1 as finished separate components for illustrative purposes.

It is now appreciated that the unit 105 and the inner shell 120 can be standardized and therefore not unique to any one particular hearing aid patient. In this way, the patient can go to a doctor, audiologist or other professional who fits hearing aids and be prescribed a hearing aid. The professional can then choose a standardized unit 105 for the patient and fit a temporary end cap 180 on the barb 117 and the patient can wear and use the unit 105 immediately. The professional can take the mold of the patient's ear canal before the patient leaves the office. After the patient leaves, the professional can then use a standardized inner shell 120 and form the outer shell 150 around the inner shell 120 based on the custom mold of the patient's ear canal. The inner shell 120 and the outer shell 150 then form the custom shell 190 that can be completely manufactured without the need for the unit 105 during the customization process. When the custom shell 190 is complete, the patient can be called back into the professional's office. The temporary end cap 180 can be removed and the custom shell 190 can then be inserted onto the stem 115 of the unit 105, and the end cap 180 then replaced permanently in order to secure the custom shell 190 onto the stem 115. IT is also now appreciated that the end cap 180 has a diameter larger than the diameter of the openings 126, 156 of the inner and outer shells 120, 150. This larger diameter of the end cap 180 allows the end cap 180 to retain the customized shell 190 on the stem 115 of the unit 105.

FIG. 1A illustrates a complete shell in shell hearing aid system 100. It is now appreciated that the inner shell 120 and outer shell 150 form the custom shell 190 that surrounds the stem 115 and secured into place by the end cap 180. By sing the standard unit 105 and standard inner shell 120, the professional can save much time and effort in completing the hearing aid system 100 and the patient receives immediate benefits of the system 100. Furthermore, the patient does not have to experience extensive delays in receiving the immediate benefits of the hearing aid system 100.

FIG. 2 illustrates a side view of an embodiment of the electronic and transducer unit 105 of an embodiment of a shell in shell hearing aid system 100. This view illustrates that the stem 115 is angled with respect to the housing 110. This angular orientation generally mimics the angular orientation of the ear canal with respect to the ear opening. Since the housing 110 an operational face 111 has to be flush with the opening of the patient's ear, the stem 115 is angled to anticipate the general angular orientation of the ear canal. This view further illustrates the generally square cross section of the stem 115 in this embodiment. A predictable cross section such as square is desirable because it removes much guess work on how the stem 115 should be fit into the customized shell 190 when it is complete. With a predictable cross section such as square, there is a single orientation into which the stem 115 fits into the stem-shell portion 125 of the inner shell 120. Although a circular cross section is contemplated, it is appreciated that the customized shell 190 may move and pivot about the stem 115. The view further illustrates that the barb 117 includes a speaker opening 118 that is covered by the end cap 180.

The description above discussed that the unit 105 alone as shown in FIG. 2 can be temporarily fitted with an end cap such as end cap 180 so that the patient can receive the immediate benefits of the hearing aid system 100. Several features and modifications of the end cap 180 are now discussed. It is appreciated in the description below that the end cap 180 includes features that prevent ear wax build-up in speaker openings of the hearing aid system as well as other conventional hearing aids.

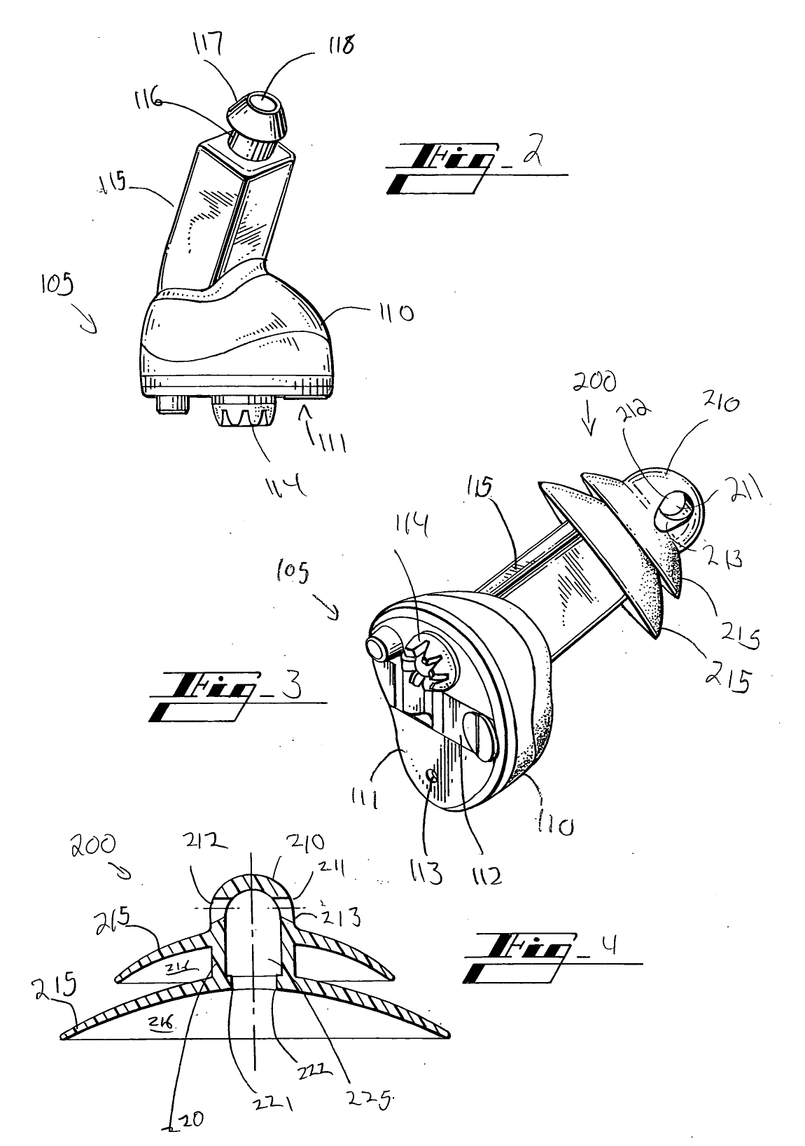

FIG. 3 illustrates a perspective view of an embodiment of the electronic and transducer housing unit 105 of an embodiment of a shell in shell hearing aid system 100 having an embodiment of a wax guard apparatus 200 connected to the barb 117 of the stem 115. While the patient is awaiting the custom shell 190 to be complete, the end cap 180 as shown in FIG. 1 may not provide a secure fit in a patient's ear canal when used alone with the unit 105 and without the securing features that the custom shell 190 can provide. As such, the apparatus 200 includes additional features that allow a more secure fit in a patient's ear canal when the unit 105 is used without the customized shell 190.

The apparatus 200 includes a dome 210 having a side channel 211 through the side of the dome 210. The side channel 211 provides a speaker opening into the patient's ear canal. By being positioned in a sideways orientation, it has been determined that wax build-up is prevented. As described above, with conventional hearing aids the speaker opening is located parallel to the path that the hearing aid travels when it is inserted into the ear canal, which can cause wax build-up in the opening. In contrast, the sideways orientation of the channel 211 places the channel perpendicular to the path of travel when the unit 105 is inserted into the ear canal. As such, wax can pass by the channel 211, instead of packing directly into the channel 211. In addition, the bell-shape of the dome 210 allows wax to pass by and over the dome 210. The channel 211 includes a tear-shaped opening 212 that not only defines the overall opening to the channel 211, but also provides a small indentation 213 defining the peak of the tear shape. This overall tear shape of the opening 212 as well as the indentation 213 allows wax to further “pass by” the opening 212 and channel 211 thereby preventing overall wax build-up.

The apparatus 200 further includes one or more flap seals 215 generally connected to the apparatus 200 below the dome 210. In general, the flap seals 215 become larger as they are positioned closer to the stem 115. The flap seals 215 provide a sealing mechanism in the patient's ear canal. When the unit 105 (or entire hearing aid system 100) is inserted in the ear canal when using the apparatus 200, the first smaller flap seal 155 begins to form a partial vacuum in the ear canal as it causes isolation from the environment external to the ear canal. As the hearing aid is further inserted into the ear canal, the larger flap seal 215 then enters the canal and also forms a partial vacuum. With the combined effects of the multiple flap seals 215, the hearing aid can remain securely fit in the patient's ear canal. IT is now appreciated that the patient may enjoy the fit provided by the sole use of the apparatus 200 and decides that he or she does not want to have a custom shell 190 fitted onto the unit. As such, in one embodiment, the unit 105 can be used solely with the apparatus 200.

FIG. 4 illustrates a side cutaway view of an embodiment of a hearing aid wax guard apparatus 200. This view illustrates that dome 210 and the channel 211, opening 212 and indentation 213 all as described above. The view further illustrates that the dome 210 is part of an overall housing 220 having a generally hollow interior 225 of which the channel 211 is part. It is further illustrated that the first small flap seal is connected to the housing 220 at about the mid point and the second larger flap seal 215 is connected to the housing 220 adjacent an opening 221 to the housing 220. It is now further appreciated that the barb 117 of the stem 115 inserts into the opening 221 and into the hollow interior 225 of the housing 220. The barb 117 as well as the opening 221 can slightly deform as the barb 117 enters. In a typical implementation, the barb 117 typically has a largest diameter generally equal to the diameter of the hollow interior 225. As such, when the barb 117 reforms after insertion it fits well within the interior 225. Lips 222 at the opening 221 can then keep the barb 117 from being pulled out of the interior 225. With the barb 117 in place, the opening 118 on the barb 117 is acoustically coupled to the interior 225 and therefore the channel 211. In this way there is an acoustic connection between the microphone opening 113 on the operational face 111, through the unit 105 and ultimately through the opening 212 on the apparatus 200. The view further illustrates that each flap seal 215 has an overhang forming a space 216 under each flap seal 215.

FIG. 5 illustrates a side view of an embodiment of a shell in shell hearing aid system end cap 180. It is now appreciated that the end cap 180 and the apparatus 200 are very similar in that the end cap further includes features of the apparatus 200 including a dome 181, channel 182, opening 183, indentation 184 and housing that includes a hollow interior to coupled with the barb 117 as described with respect to FIG. 4 above.

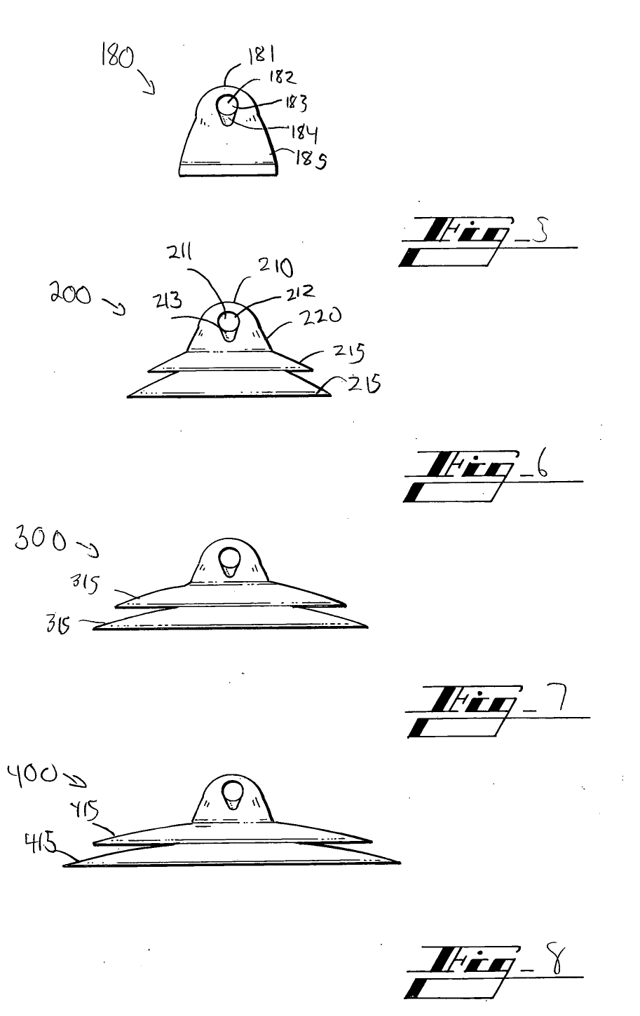

FIG. 6 illustrates a side view of an embodiment of a hearing aid wax guard apparatus 200 as described above. The features include the dome 210, channel 211, opening 212, indentation 213, housing 220 with hollow interior 225 as well as flap seals 215.

FIGS. 7 and 8 illustrate side views of other embodiments of hearing aid wax guard apparatuses 300, 400. These apparatuses 300, 400 generally include the same features and functions as the end cap and apparatus 200 described above. The main feature of the apparatuses 300, 400 that differs from the other embodiments is an increasing flap seal 315, 415 diameter. The end cap 180 and the apparatuses 200, 300, 400 all provide different options for different patients with differing ear canal shape and size. Patient's with very small ear canals may be able to use the end cap, while patients with large ear canals may require the apparatus 400 with the largest flap seals 415.

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

1. A hearing aid apparatus, comprising:
a electronics and transducer unit;
a custom shell connected to and surrounding a portion of the unit; and
an end cap connected to the unit.

2. The apparatus as claimed in claim 1 wherein the unit comprises a housing and a stem connected to the housing.

3. The apparatus as claimed in claim 2 further comprising a protrusion connected to the stem and a barb connected to the protrusion.

4. The apparatus as claimed in claim 1 wherein the custom shell comprises an inner shell nested in an outer shell.

5. The apparatus as claimed in claim 4 wherein the inner shell surrounds the stem.

6. The apparatus as claimed in claim 5 wherein the stem is surrounded by a stem-shell portion of the inner shell and wherein the housing is cradled in a housing-shell portion of the inner shell.

7. The apparatus as claimed in claim 2 further comprising a longitudinal axis defined along the stem and along the custom shell.

8. The apparatus as claimed in claim 7 wherein the end cap includes a speaker opening oriented perpendicular to the longitudinal axis.

9. The apparatus as claimed in claim 3 wherein the end cap further comprises an opening oriented along the longitudinal axis and connected to the barb.

10. A hearing aid kit, comprising:
an electronics and transducer unit having a housing and a stem having a protrusion and a barb;
an inner shell optionally adapted to fit onto and surround the stem and to cradle a portion of the housing, the inner shell having a housing shell portion and a stem-shell portion;
an outer shell adapted to be formed around the inner shell, the outer shell having an outer surface molded to an ear canal; and
an end cap having an opening adapted to receive the barb, the end cap being adapted to retain the inner and outer shells on the stem.

11. The kit as claimed in claim 10 wherein the end cap is further adapted to connect to the stem in the absence of the inner and outer shells.

12. The kit as claimed in claim 11 further comprising flap seals connected to a housing portion of the end cap, the flap seals being adapted to retain the hearing aid in an ear canal in the absence of the inner shell.

13. The kit as claimed in claim 11 wherein the barb includes a speaker opening adapted to fit into a hollow interior of the end cap.

14. The kit as claimed in claim 13 wherein the end cap includes an opening oriented about a longitudinal axis common to a longitudinal axis of the barb speaker opening and a side speaker channel oriented generally perpendicular to the longitudinal axis.

15. The kit as claimed in claim 14 wherein the barb speaker opening is acoustically coupled to the side speaker channel when the opening of the end cap is connected to the barb.

16. A hearing aid system, comprising:
an electronics and transducer unit having a housing and a stem having a protrusion and a barb, the housing having an operational face including a transducer opening;
an inner shell surrounding the stem and cradling a portion of the housing, the inner shell having a housing shell portion, a stem-shell portion and an opening through which the protrusion and barb protrude;
an outer shell surrounding the inner shell, the outer shell having an outer surface molded to an ear canal; and
an end cap having an opening connected to the barb, the end cap having a diameter larger than the diameter of the opening of the inner shell through which the protrusion and barb protrude, thereby retaining the inner and outer shells on the stem,
wherein the stem, the inner and outer shells and the end cap are oriented about a common longitudinal axis.

17. The apparatus as claimed in claim 16 wherein the barb includes a speaker opening that is located within a hollow interior of the end cap.

18. The apparatus as claimed in claim 17 wherein the end cap includes a side channel speaker opening oriented generally perpendicular to the longitudinal axis and acoustically coupled to the hollow interior and to the speaker opening on the barb.

19. A wax guard apparatus, comprising:
a housing having a dome and a hollow interior, the housing being oriented about a longitudinal axis;
a side channel through the dome and oriented generally perpendicular to the longitudinal axis;
an opening to the side channel, the opening defining a tear drop a portion of the tear drop being disposed through the channel, and another portion of the teardrop forming an indentation; and
an opening to the hollow interior oriented about the longitudinal axis opposite the dome, the opening defining a lip adjacent the opening.

20. The apparatus as claimed in claim 19 further comprising a first flap seal connected to a mid point location on the housing and being oriented about the longitudinal axis.

21. The apparatus as claimed in claim 20 wherein the first flap seal overhangs about the housing forming a space underneath the flap seal and about the housing.

22. The apparatus as claimed in claim 21 further comprising a second flap seal located adjacent the opening oriented about the longitudinal axis, the second flap seal having a diameter larger than the diameter of the first flap seal.

23. A hearing aid, comprising:
an electronics and transducer unit having a stem and a housing;
means to receive and surround a portion unit;
means to surround the means to receive and surround a portion of the unit; and
means to retain the means to receive and surround the unit on the unit.
